(19) United States
(12) Patent Application Publication
(10) Pub. No.: US 2026/0328983 A1
(43) Pub. Date: Oct. 22, 2026

(54) OPTICAL DEVICE FOR AUGMENTED REALITY

(71) Applicant: CLAROPTIC CO., Ltd., Seongnam-si (KR)

(72) Inventor: Min-kyu SONG, Seoul (KR)

(21) Appl. No.: 19/216,246

(22) Filed: May 22, 2025

(30) Foreign Application Priority Data
Apr. 16, 2025 (KR) 10-2025-0049207

(51) Int. Cl. F21V 8/00

(52) U.S. Cl. CPC G02B 6/0035; G02B 6/0088

(57) ABSTRACT

One aspect of an embodiment provides an optical device for augmented reality that is configured to provide a user with virtual light outputted from a display module and real light from a real world. The optical device may include: an optical structure having a first portion through which the virtual light enters and a second portion through which the real light enters; a first optical element placed within the optical structure to transmit or reflect the virtual light depending on the angle of incidence; and a second optical element configured to reflect the virtual light that has been transmitted through the first optical element, wherein the virtual light outputted from the display module may arrive at the first optical element after being reflected at the second portion.

### CROSS-REFERENCE TO RELATED APPLICATIONS

This application claims the benefit of Korean Patent Application No. 10-2025-0049207, filed with the Korean Intellectual Property Office on Apr. 16, 2025, the disclosure of which is incorporated herein by reference in its entirety.

### BACKGROUND

### 1. Technical Field

The invention relates to an optical device for augmented reality that provides the user with a virtual image and a real image simultaneously.

### 2. Description of the Related Art

Augmented reality (AR) is a technology that involves overlaying digital information onto the real world. Through augmented reality, a user using a smart phone, eyeglasses, a headset, or the like, is able to see a virtual image and the actual environment together in real time. This technology, which is being utilized in various fields such as gaming, education, medicine, manufacture, etc., is based on reality but expands the user’s experience by adding virtual elements.

A device for implementing augmented reality may include hardware and software by which to recognize the real world and display virtual information. Here, a hardware device may include a smart phone, a tablet, AR eyeglasses, a HMD (head-mounted display), etc. Such a device may utilize a camera, sensor, GPS, etc., to identify the position of the user and the surrounding environment, and may overlay a 3D graphic, text, image, etc., in real time on the screen based on the identified information, thereby allowing the user to experience both the real world and the virtual information simultaneously.

Optical devices for augmented reality that are being developed in recent times are often produced in a form that is wearable by the user, as is the case for AR eyeglasses. Thus, there is a need for an optical device having a decreased thickness and reduced weight.

### Prior Art

(Patent Document 1) Korean Patent Publication No. 2018-0043072

### SUMMARYOF THE INVENTION

An aspect of the invention, which was conceived to resolve the problem described above, is to provide an optical device for augmented reality that allows a decrease in thickness.

Other objectives of the invention will be more clearly understood from the embodiments set forth below.

One aspect of the invention provides an optical device for augmented reality that is configured to provide a user with virtual light outputted from a display module and real light from a real world. The optical device may include: an optical structure having a first portion through which the virtual light enters and a second portion through which the real light enters; a first optical element placed within the optical structure to transmit or reflect the virtual light depending on the angle of incidence; and a second optical element configured to reflect the virtual light that has been transmitted through the first optical element, wherein the virtual light outputted from the display module may arrive at the first optical element after being reflected at the second portion.

An optical device for augmented reality according to an embodiment of the invention can include one or more of the following features. For example, coating layers of the same material can be formed on both surfaces of the first optical element such that an optical path of the virtual light transmitted through the first optical element is unchanged. The coating layers can be aspherical in shape. Also, an optical path of the virtual light can be adjusted by the coating surfaces depending on the position of incidence when the virtual light is reflected at the first optical element.

The incidence angle of the virtual light being transmitted through the first optical element can be smaller than the incidence angle of the virtual light being reflected at the first optical element.

The optical structure can include a third portion through which the virtual light and the real light are outputted to the user.

the virtual light reflected at the second optical element can be incident on and reflected at the third portion, and the virtual light reflected at the third portion can be reflected at the first optical element to be outputted in the direction of the user.

An embodiment of the invention having the features above can provide various advantageous effects including the following. However, an embodiment of the invention may not necessarily exhibit all of the effects below.

An embodiment of the invention can provide an optical device for augmented reality having a decreased thickness.

Also, an embodiment of the invention can provide an optical device for augmented reality having a high light efficiency.

### BRIEF DESCRIPTION OF THE DRAWINGS

FIG. 1 illustrates how virtual light and real light are transferred to the user by an optical device for augmented reality according to an embodiment of the invention.

FIG. 2 is a diagram illustrating an optical device for augmented reality according to an embodiment of the invention.

FIG. 3 is a diagram illustrating the incidence angles of virtual light being transmitted through a first optical element and virtual light being reflected by the first optical element in an optical device for augmented reality according to an embodiment of the invention.

FIG. 4 is a diagram illustrating an optical device for augmented reality according to a second disclosed embodiment of the invention.

### DETAILED DESCRIPTIONOF THE INVENTION

As the invention allows for various changes and numerous embodiments, particular embodiments will be illustrated in the drawings and described in detail in the written description. However, this is not intended to limit the invention to particular modes of practice, and it is to be appreciated that all changes, equivalents, and substitutes that do not depart from the spirit and technical scope of the invention are encompassed by the invention. In the description of the invention, certain detailed explanations of the related art are omitted if it is deemed that they may unnecessarily obscure the essence of the invention.

The terms used in the present specification are merely used to describe particular embodiments and are not intended to limit the invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added.

While such terms as “first” and “second,” etc., can be used to describe various components, such components are not to be limited by the above terms. The above terms are used only to distinguish one component from another.

Certain embodiments of the invention will be described below in more detail with reference to the accompanying drawings. Those components that are the same or are in correspondence are rendered the same reference numeral, and redundant descriptions are omitted.

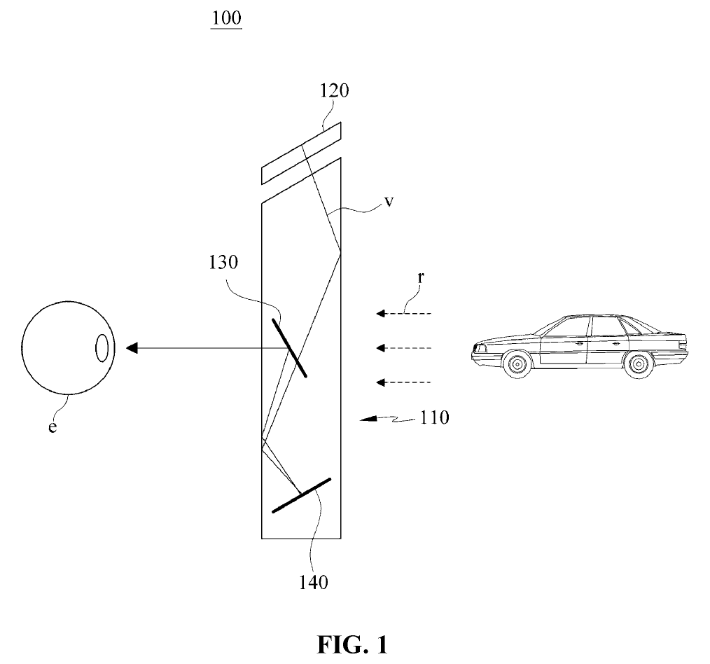

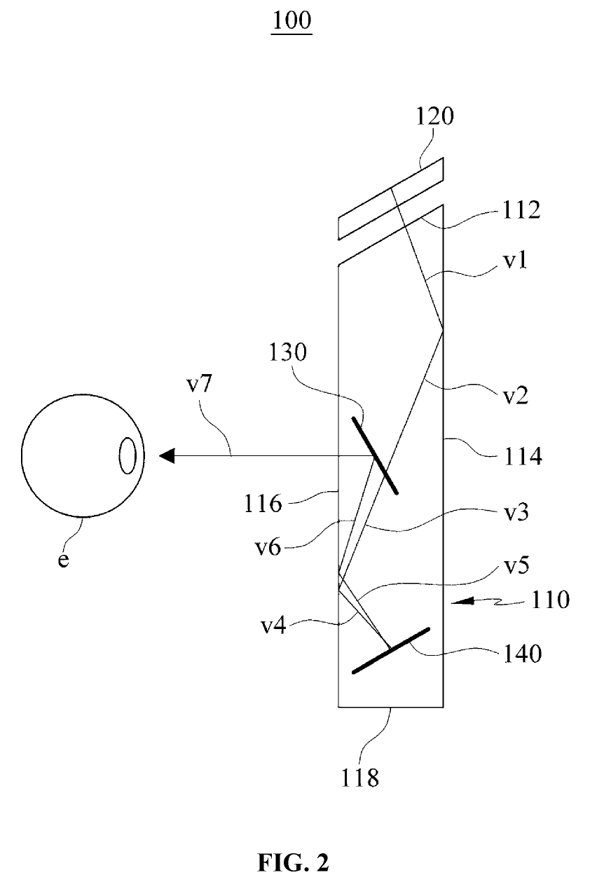

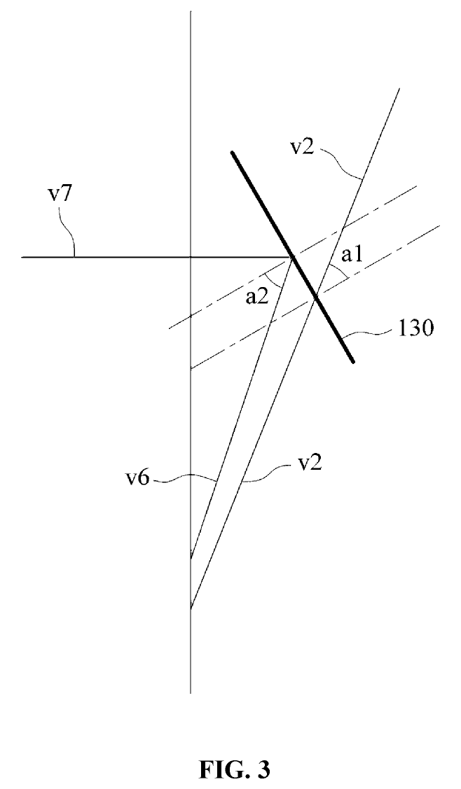

FIG. 1 illustrates how virtual light v and real light r are transferred to the user by an optical device 100 for augmented reality according to an embodiment of the invention. FIG. 2 is a diagram illustrating an optical device 100 for augmented reality according to an embodiment of the invention, and FIG. 3 is a diagram illustrating the incidence angles a1, a2 of virtual light v3 being transmitted through a first optical element 130 and virtual light v6 being reflected by the first optical element 130 in an optical device 100 for augmented reality according to an embodiment of the invention.

Referring to FIGS. 1-3, an optical device 100 for augmented reality according to the first disclosed embodiment may provide a virtual image and an actual image by providing the user with virtual light v outputted from a display module 120 and real light r from the real world. An optical device 100 for augmented reality according to the first disclosed embodiment may include an optical structure 110, a first optical element 130, and a second optical element 140.

A virtual image may be emitted from the display module 120, reflected off a second portion 114 of the optical structure 110, and then be transferred to the user e (for instance, a pupil of the user) by way of the first optical element 130 and second optical element 140. The real light r, which originates from objects of the actual world, can pass through the second portion 114 and third portion 116 of the optical structure 110 to be transferred to the user. Thus, the optical device 100 can provide augmented reality by providing a virtual image and a real image to the user simultaneously.

While an optical device 100 for augmented reality based on this embodiment can be implemented as a device shaped as a pair of eyeglasses, the invention is not limited by the shape and usage of the optical device.

The display module 120 for generating the virtual image can correspond to a display based on micro display, transparent OLED, LCOS (liquid crystal on silicon), DLP (digital light processing), and LED, etc. Such a display module is generally fabricated in a small size of 0.2 to 1 inch and is characterized by allowing miniaturization while maintaining high resolution and high luminance. The display module 120 can be installed at a position close to the user’s eye (e.g., within a pair of eyeglasses) and can provide a virtual image, which may be adjusted by the optical structure 110 to be naturally overlaid onto the real image. In particular, in augmented reality eyeglasses, a transparent display can be inserted into the lens itself or be placed in the frame so as to provide information without obstructing the view.

In an optical device 100 for augmented reality based on this embodiment, the display module 120 can be placed on one side on the exterior of the optical structure 110.

The optical structure 110 can have a particular shape (for instance, the shape of a lens) and can be formed from a glass or transparent synthetic resin material that is capable of transmitting real light r. The optical structure 110 can be formed from a material having a certain transparency and refractive index, where the light transmissivity can be adjusted by forming a coating layer on an external surface (for instance, the second portion 114).

The optical structure 110 can include a first portion 112 through which the virtual light v for the virtual image generated by the display module 120 enters. The optical structure 110 can also include a second portion 114, through which the real light r for real images generated by real objects enters, and a third portion 116, through which the virtual light and the real light may be outputted to the user e. In cases where the optical structure 110 is shaped as an eyeglass lens, the second portion 114 can correspond to the surface arranged on the side of the real object, while the third portion 116 can correspond to the surface arranged on the user side.

The first portion 112 can correspond to a surface where the display module 120 is arranged, between the second portion 114 and third portion 116, and a fourth portion 118 can correspond to a surface arranged opposite the first portion 112, between the second portion 114 and third portion 116.

Each of the first portion 112, second portion 114, third portion 116, and fourth portion 118 can be formed as a flat plane, a curved plane, or a combination thereof.

The display module 120 can be arranged in an inclined position, such that the virtual light v emitted from the display module 120 may be incident on the second portion 114 at an inclined angle. The first portion 112 can also be formed with an incline, in the same manner as the display module 120 arranged in an inclined position, and the display module 120 and the first portion 112 can be arranged to be parallel to each other.

The virtual light v1 outputted from the display module 120 can arrive at the first optical element 130 after being reflected off the inner surface of the second portion 114. As the virtual light v1 outputted from the display module 120 arrives after being reflected at the second portion 114, instead of arriving at the first optical element 130 directly, the incidence angle of the virtual light v2 arriving at the first optical element 130 can be decreased. The decreased incidence angle of the virtual light v2 can prevent optical loss, thereby increasing light efficiency and making it possible to reduce the thickness of the optical structure 110.

The first optical element 130 and the second optical element 140 can be positioned within the optical structure 110.

The virtual light v2 reflected off the second portion 114 of the optical structure 110 may arrive at the first optical element 130, where the first optical element 130 can transmit or reflect the virtual light v1, v6 depending on the incidence angle. That is, the virtual light v2 that arrives after being reflected at the second portion 114 of the optical structure 110 can be transmitted through the first optical element 130, to subsequently arrive at and be reflected by the third portion 116. The virtual light v6 that is reflected at the third portion 116 may be reflected by the first optical element 130 to become virtual light v7. The virtual light v7 reflected at the first optical element 130 can be transferred to the user e.

A coating layer (no numeral assigned) can be formed on the first optical element 130. The coating layer can correspond to a dielectric coating layer, where the dielectric coating layer can be formed by magnesium oxide, calcium fluoride, and oxides of various metals. The reflectivity and transmissivity of such a dielectric coating layer can be determined in accordance with the angle of the incident light. Therefore, the reflectivity and transmissivity of the first optical element 130 can be adjusted by factors such as the thickness, number of layers, and composition, etc., of the dielectric coating layer.

The coating layer can be formed on one surface or both surfaces of the first optical element 130. In cases where coating layers are formed on both surfaces, the coating layers can be formed with the same structure, so that the optical path of the virtual light being transmitted through the first optical element 130 may remain unchanged.

In the first optical element 130, the surface where the virtual light v6 is reflected can be formed as an asphere, so that the virtual light v6 may be reflected by the first optical element 130 and provided to the user e. As the coating layer is formed as an asphere, the optical path of the virtual light v6 can be adjusted depending on the position of incidence, and an augmented reality image can be generated. Of course, the coating layers formed on both surfaces of the first optical element 130 can both be formed as aspheres.

Referring to FIG. 3, the incidence angle a1 of the virtual light v2 arriving at the first optical element 130 and the incidence angle a2 of the virtual light v6 arriving at the first optical element 130 can be different from each other. The incidence angle a2 can be formed to be greater than the incidence angle a1, whereby the virtual light v6 can be totally reflected without being transmitted through the first optical element 130. The incidence angles a1 and a2 can both be greater than 0 degrees and smaller than 45 degrees.

The virtual light v3 that has been transmitted through the first optical element 130 may be reflected off the inside of the third portion 116 of the optical structure 110 to become reflected virtual light v4, which in turn may arrive at the second optical element 140. The second optical element 140 may reflect the virtual light v4 towards the third portion 116 of the second optical element 140. To this end, the second optical element 140 may be arranged in an inclined position facing the third portion 116 of the optical structure 110.

The virtual light v5 reflected by the second optical element 140 may be reflected off the third portion 116 of the optical structure 110, and the resulting virtual light v6 may be incident on the first optical element 130. The virtual light v6 arriving at the first optical element 130 can be reflected by the first optical element 130, and the resulting virtual light v7 can be transferred to the user e.

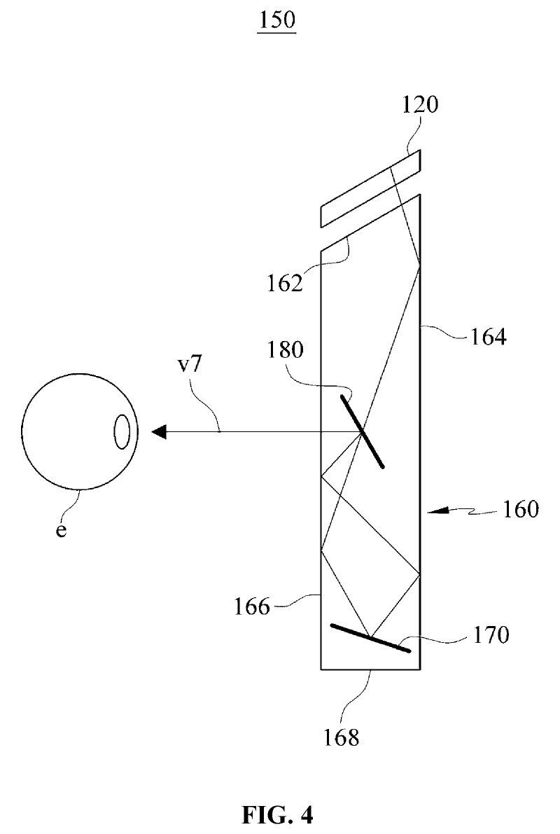

FIG. 4 is a diagram illustrating an optical device 150 for augmented reality according to a second disclosed embodiment of the invention.

Referring to FIG. 4, an optical device 150 for augmented reality based on the second disclosed embodiment may be substantially the same as an optical device 100 for augmented reality based on the first disclosed embodiment, in that it includes an optical structure 160, a first optical element 130, and a second optical element 140, but may differ in that the distance between the second optical element 140 and the first optical element 130 are greater than in the optical device 100 of the first disclosed embodiment.

The optical structure 160 may include a first portion 162, a second portion 164, a third portion 166, and a fourth portion 168, but as these are the same as or similar to the portions of the optical structure 110 based on the first disclosed embodiment, they will not be described in further detail. However, in the optical device 150 for augmented reality based on the second disclosed embodiment, the second optical element 140 may be further separated from the first optical element 130, so that the thickness of the optical structure 160 can be decreased even further, and the arrangements of the optical elements 130, 140 can be designed with greater flexibility.

While the foregoing provides a description with reference to an embodiment of the invention, it should be appreciated that a person having ordinary skill in the relevant field of art would be able to make various modifications and alterations to the invention without departing from the spirit and scope of the invention set forth in the scope of claims below.

What is claimed is:

1. An optical device for augmented reality, the optical device configured to provide a user with virtual light outputted from a display module and real light from a real world, the optical device comprising:
an optical structure having a first portion through which the virtual light enters and a second portion through which the real light enters;
a first optical element placed within the optical structure to transmit or reflect the virtual light depending on angle of incidence; and
a second optical element configured to reflect the virtual light that has been transmitted through the first optical element,
wherein the virtual light outputted from the display module arrives at the first optical element after being reflected at the second portion.

2. The optical device of claim 1, wherein coating layers of a same material are formed on both surfaces of the first optical element such that an optical path of the virtual light transmitted through the first optical element is unchanged.

3. The optical device of claim 2, wherein the coating layers are aspherical in shape.

4. The optical device of claim 3, wherein an optical path of the virtual light is adjusted by the coating surfaces depending on position of incidence when the virtual light is reflected at the first optical element.

5. The optical device of claim 1, wherein an incidence angle of the virtual light being transmitted through the first optical element is smaller than an incidence angle of the virtual light being reflected at the first optical element.

6. The optical device of claim 1, wherein the optical structure includes a third portion through which the virtual light and the real light are outputted to the user.

7. The optical device of claim 6, wherein the virtual light reflected at the second optical element is incident on and reflected at the third portion, and
the virtual light reflected at the third portion is reflected at the first optical element to be outputted in a direction of the user.
